(19) United States
(12) Patent Application Publication
(10) Pub. No.: US 2017/0364797 A1
(43) Pub. Date: Dec. 21, 2017

(54) Computing Systems and Methods for Determining Sentiment Using Emojis in Electronic Data

(71) Applicant: Sysomos L.P., Toronto (CA)

(72) Inventors: Koushik PAL, Etobicoke (CA); Kanchana PADMANABHAN, Toronto (CA); Dhruv MAYANK, Toronto (CA)

(73) Assignee: Sysomos L.P., Toronto (CA)

(21) Appl. No.: 15/624,100

(22) Filed: Jun. 15, 2017

Related U.S. Application Data
(60) Provisional application No. 62/351,196, filed on Jun. 16, 2016.

(51) Int. Cl. G06N 3/08; G06Q 50/00

(52) U.S. Cl. CPC G06N 3/08; G06Q 50/01

(57) ABSTRACT

Social media networks have become a primary source for news and opinions on topics ranging from sports to politics. Sentiment analysis is typically constrained to two classes—positive and negative. A computing system is herein described for building a multi-sentiment multi-label model for electronic data that uses emojis as class labels. The electronic messages are classified into six sentiment classes. The computing system collects and creates a large corpus of clean and processed training data with emoji-based sentiment classes using little-to-no manual intervention. A threshold-based formulation is used to assign one or two class labels (multi-label) to an electronic message. The multi-sentiment multi-label model produces a desirable cross validation accuracy.

### CROSS-REFERENCE TO RELATED APPLICATIONS

This application claims priority to U.S. Provisional Patent Application No. 62/351,196 filed on Jun. 16, 2016, entitled “Computing Systems and Methods for Determining Sentiment Using Emojis in Electronic Data” and the entire contents of which is incorporated herein by reference.

### TECHNICAL FIELD

The following relates to multi-sentiment classification using emojis.

### DESCRIPTION OF THE RELATED ART

Social media often includes emojis to display a feeling. Emojis are images, such as a happy face or sad face, that can express other information beyond or in addition to text. Emojis are very common in instant messaging, text messaging, chat software, social media, and message boards. Emojis are also becoming more popular in other types of electronic data, such as online posts, online articles, and in videos.

### BRIEF DESCRIPTION OF THE DRAWINGS

Embodiments will now be described by way of example only with reference to the appended drawings wherein:

FIG. 1 is an example embodiment of a system diagram showing electronic data including emojis being transmitted.

FIG. 2 is an example embodiment of a system diagram showing a detailed view a computing system for analyzing the electronic data having emojis.

FIG. 3 is a graph showing example data results of different types of emojis in experimental data.

FIG. 4 is a graph showing example data results of accuracy based on experimental data.

FIG. 5 is an example of computer executable or processor implemented instructions for determining sentiment of a message based on emojis.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Social data networks such as those under the trade names Twitter, Facebook, Instragram, and Tumblr are popular opinion and information sharing platforms among billions of Internet users. People are keen to post opinions about a variety of topics such as products, movies, music, politics, and current affairs. Social network engagement (e.g. people using their electronic devices to post or share about a specific topic) has become a significant measure of success for a product, or movie, or even something as important as political candidacy. Volume of engagement alone is in-sufficient to judge success. The measure of success is deeply coupled with the volume of a particular sentiment. Measure of sentiment often affects how a marketer, a celebrity, or a political party reacts to a situation. Below in an example of a social media post with negative connotation and a reply from the company 6 min later. The authors of the tweets have been made anonymous.

### Example

Tweet: Booked a full-size car @XYZ, as Gold member; too bad, no more, pick a small car. Then they don't reduce the price. #RipOff (3:17 PM)
Reply: @XXXX Hi XX, We're sorry to hear that. Please DM us your rental info. We'd like to look into this. (3:22 PM)

It will be appreciated that “tweets” are a type of electronic message sent over the social data network Twitter. While many of the example described herein relate to Twitter, the principles described herein apply to many types of digital data that includes emojis. For example, online newspapers, online blogs, RSS feeds, social media networks, mobile communication applications, chat applications, video sharing websites, websites, etc. may have electronic data (e.g. digital text, digital video, digital images, etc.) that include emojis. The terms electronic data and electronic messages are herein used interchangeably.

Social media is part of the big data revolution and hence understanding sentiment of posts has to be a machine learned task. Existing computing systems are configured to solve a binary problem of discerning if an electronic message has positive or negative sentiment. However, it is herein recognized that humans express emotions in more than two ways. For example, there are about 6 emotion classes with 42 different degrees of emotion. Healey and Ramaswamy have developed a twitter sentiment vizualization based on Russell model of eight emotional effects that uses ANEW (Affective Norms for English Words). Hence, a binary classification is no longer sufficient. Therefore, it is herein recognized that it is desirable for computing systems to have a multi-sentiment model to predict the different human emotions. It is additionally herein recognized that the same electronic message may express more than one emotion and that requires a multi-sentiment multi-label model.

Social media posts are typically shorter, casual, and in general not well constructed (in comparison to other Internet websites such as those under the trade names Amazon, Yelp, or IMDB). This poses two specific challenges for the multi-sentiment problem. First, it is hard for a computing system to gathering training data for a classification task. Second, the data has to pass through several carefully constructed pre-processing steps before the computing system can apply a classifier process to the data.

A sentiment model may be trained on data that is (semi-) manually tagged into the different sentiment classes. This requires humans to read a text, understand the sentiment, and use software programs to apply data tags to the data to indicate the relevant class. The short and ill-constructed social media posts often make it difficult to arrive at the right tag. This task becomes even harder when moving into the multi-sentiment domain. Certainly, this task is even more difficult for a computing system to automatically complete with little or no human intervention.

Computing systems and methods are herein described that use emojis as sentiment class labels to obtain training data with little to no human intervention. Social networks (and other messaging platforms) allows a user to express emotions through special characters called emojis. Emojis allow people to express a positive [e.g. :)] or negative [e.g. :(] emotion. Emojis also allow a variety of other basic emotions (e.g. happy, sad, amused, and anger) and the different degrees of emotions (e.g. mad with rage vs. disappointed) to be conveyed over electronic data. Emojis help unify and understand emotion across various writing styles; e.g, anger expressed in American english versus anger expressed in British english. This is similar to an approach that uses star ratings as polarity signals for movie reviews.

By way of background, emojis are data representing ideograms and smileys used in electronic messages and Web pages. The characters, which are used much like ASCII emoticons or kaomoji, exist in various genres, including facial expressions, common objects, places and types of weather, and animals. For example, with NTT DoCoMo's i-mode, each emoji is drawn on a 12×12 pixel grid. When transmitted, emoji symbols are specified as a two-byte sequence, in the private-use range E63E through E757 in the Unicode character space, or F89F through F9FC for Shift JIS. The basic specification has 1706 symbols, with 76 more added in phones that support C-HTML 4.0. Emoji pictograms by the Japanese mobile phone brand au are specified using the IMG tag. SoftBank Mobile emoji are wrapped between SI/SO escape sequences (where SI is “shift in” and SO and “shift out”), and support colors and animation. DoCoMo's emoji are a compact data format to transmit while au's version may be considered more flexible and based on open standards. Some emoji character sets have been incorporated into Unicode, a standard system for indexing characters, which has allowed them to be used outside Japan and to be standardized across different operating systems. Hundreds of emoji characters were encoded in the Unicode Standard in version 6.0 released in October 2010 (and in the related international standard ISO/IEC 10646).

It will be appreciated that emojis may be encoded in many different ways. Currently known emojis and encoding standards, as well as future known emojis and encoding standards are applicable to the principles described herein.

Using emojis as sentiment class labels provides us a way of obtaining training data automatically. Interestingly, in an example embodiment, a model constructed using 49 emojis as class labels yielded an accuracy of <10%. This is because emojis are messy and often incorrectly used thereby requiring significant systematic pre-processing to make them usable.

A systematic methodology is herein described to build a multi-sentiment multi-label computing system for Twitter data that uses emojis to generate sentiment class labels. Several issues that occur when using emojis (e.g., emojis that look similar but convey entirely different meanings) are described and possible solutions to the issues. The computing system uses a Word2Vec approach to group emojis into sentiment class labels that can then be used to train the classifier in-place of the raw emojis. The computing system also uses a new threshold based formulation to choose the best one or best two sentiment labels for a given electronic message (e.g. a given tweet).

In example tests, the computing system configured with the multi-sentiment multi-label model used 6 different sentiment classes and produced a 10-fold cross validation accuracy of 71:6±0:22%. The binary (positive vs. negative) classifier on the computing system produced an accuracy of 84:95±0:17%, which is better than other known methodologies.

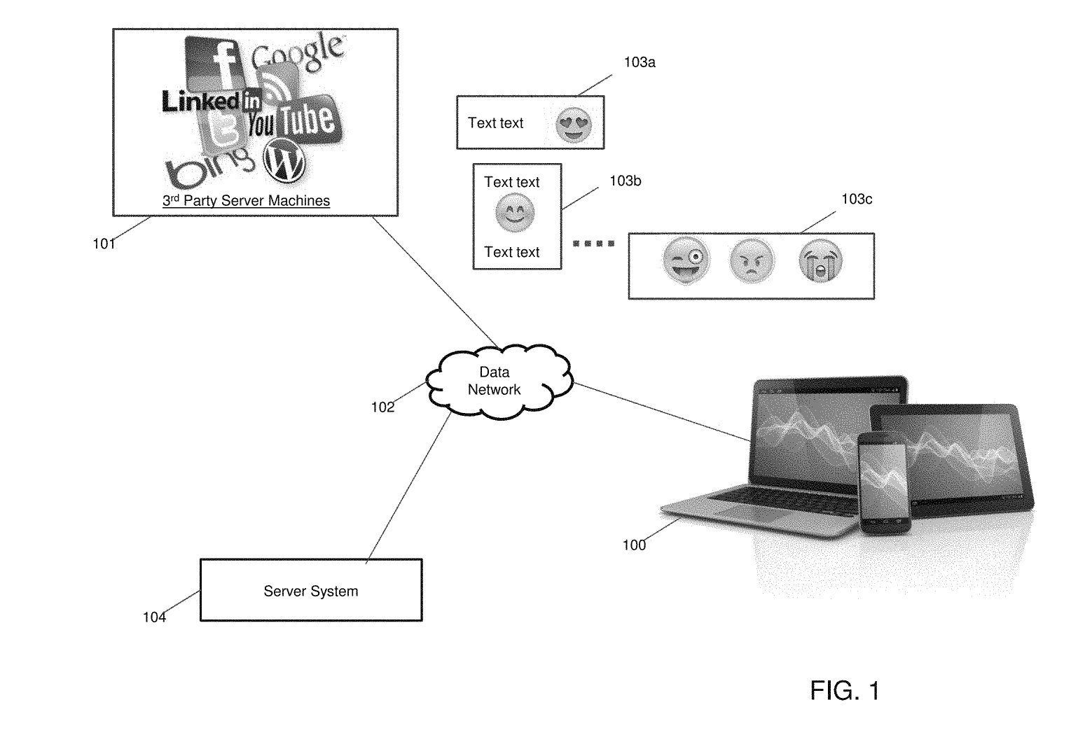

Turning to FIG. 1, user devices 100 communicate with each other and with 3^{rd} party server machines 101 over a data network 102 (e.g. the Internet, the mobile network, etc.). Electronic data items 103a, 103b, 103c are transmitted over the data network 102. These electronic data items include various types of emojis. These electronic data items are more generally referenced by the numeral 103.

The 3^{rd} party server machines 101 include, for example, those for supporting online newspapers, online blogs, RSS feeds, social media networks, mobile communication applications, chat applications, video sharing websites, websites, etc.

The user devices 100 include, for example, but are not limited to, laptops, desktop computers, tablets, wearable devices, mobile phones, personal digital assistants, in-vehicle computers, and computer kiosks.

The server system 104 is able to access and collect the electronic data items via the data network 102 to analyze the collected data. The server system, also called a computing system, is able to further output classifications identifying sentiment of each electronic data item based on the emoji(s) included in each data item.

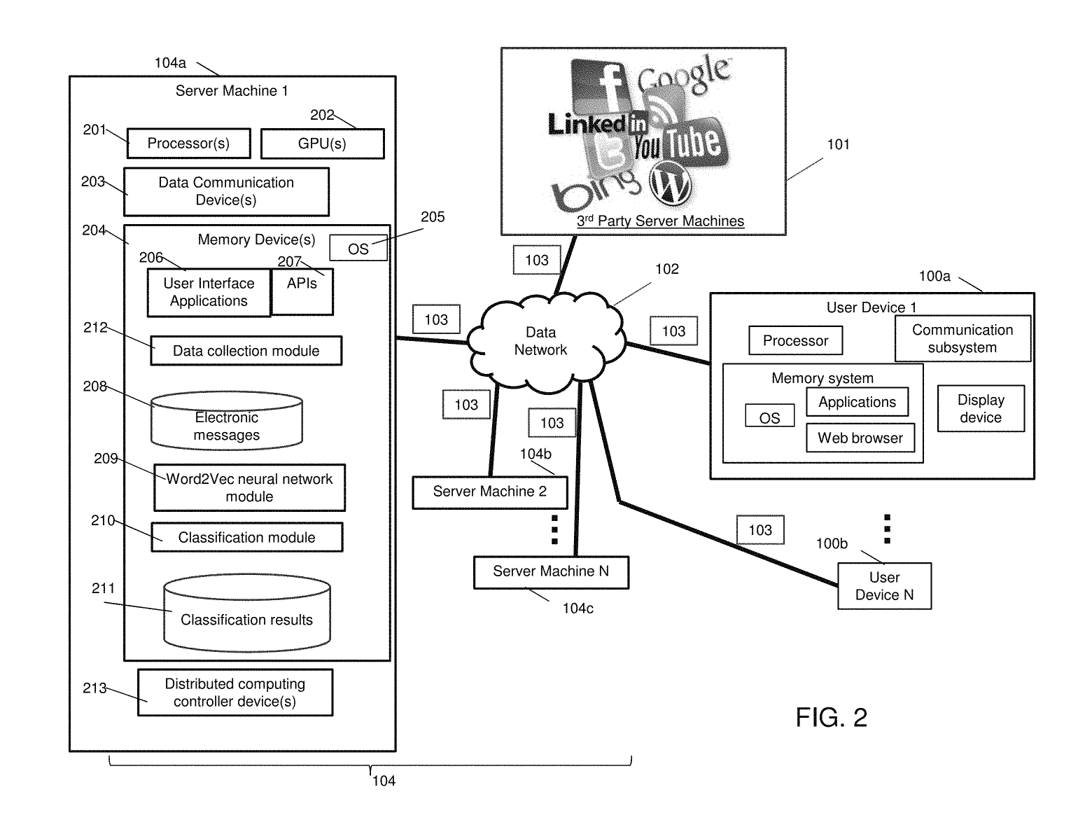

Turning to FIG. 2, a more detailed view of the computing system is shown. The server system 104 includes one or more server machines 104a, 104b, 104c that perform distributed computing. For example, the server machine 104 a includes one or more processors 201 and one or more graphic processing units (GPUs) 202. Although GPUs are typically used for processing graphics, the system 104 uses the one or more GPUs to perform neural network computations, including but not limited to Word2Vec neural network computations.

The server machine also includes one or more data communication devices 203 for receiving and transmitting data over the data network 102. The server machines also includes one or more memory devices 204, which stores thereon an operating system 205, one or more user interface applications 206, one or more application programming interfaces 207, a data collection module 212, an electronic messages database 208, a Word2Vec neural network module 209, a classification module 210, and a classification results database 211. There may also be a distributed computing controller device 213 to manage the distributed computing operations amongst the different server machines in the computing system 104.

Different instances of user devices 100a, 100b are shown. An example of a user device includes a processor, a communication subsystem, and a display devices. The user device may also include a memory system that includes an operating system, one or more applications and a web browser. For example, the applications or the web browser, or both, are used to facilitate viewing and generating data, including data with emojis. The electronic messages 103 having emojis are transmitted amongst the different computing devices and systems.

Methodology

A. Problem Definition

Given a set S of tweets and a set E of emojis that convey some sentiment, a training set T={(s,e)|sεS,eεE} is generated using tweets that have (single) emojis. The emojis act as the sentiment labels for the tweets and hence a many-to-one relationship exists between S and E.

The goal is to train a classifier model using training data T so that tweets with no emojis (or non-sentiment emojis) can be assigned a sentiment. The emojis convey several different sentiments such as happy, sad, angry, and love. Thus, the problem moves beyond the typical positive-negative binary classification to the multi-sentiment do-main. Moreover, using emojis as class labels mitigates the problems and need for a human to perform manual tagging of training data.

B. Emoji Selection

A first step in the process is the selection of emojis that can act as class labels and good representatives of several human sentiments.

In an example embodiment, the computing system 104 collected a data set of 49 emojis using 38.1 million tweets. This data, for example, was stored in the database 208. It is herein recognized that emojis may be used in unexpected or unconventional ways.

It was observed that the emojis that were considered offenders include 1f601 (e.g. the Unicode representing “grinning face with smiling eyes”) and 1f62c (e.g. the Unicode representing “grimacing face”). Looking at the Twitter representation of these emojis, the similarity is evident. It is herein recognized that these two emojis are often used in place of each other. This was also confirmed when using Word2Vec neural networks where 1f601 is most similar to 1f62c. The following examples illustrate this.
Example message where 1f601 is used as 1f62c: “In the process of working on one project I have created about four more for myself 1f601”
Example message where 1f62c is used as 1f601: “this just made me even more excited to see your face 1f62c”
   Another emoji that causes a problem is 1f605 (e.g. the Unicode representing “smiling face with open mouth and cold sweat”). It is herein recognized that many messages used this emoji as if the sweat is a tear and that many messages use this emoji as just a smiley face. Here are examples of expected usage and unexpected usage:
Expected: “Day 5 of being deathly ill in bed: starting to have conversations with people in my head to pass time 1f605”
Unexpected Negative: “just thinking ab work tomorrow is making me nervous 1f605”
Unexpected Positive: “i'm ready for football season 1f605”

1f613 (e.g. the Unicode representing “face with cold sweat”) also has sweat which can be mistaken for a tear, though this is less of a problem because it already conveys a negative sentiment. 1f613 was removed from the collected data set because of the two interpretations (sad vs. disappointed) in which it is being used. There are other emojis with multiple meanings such as this. 1f610 (e.g. the Unicode representing “neutral face”) used by some as a completely neutral emoji, while others use it to convey annoyance, similar to 1f611 (e.g. the Unicode representing “expressionless face”). 1f62b (e.g. the Unicode representing “tireless face”) and 1f629 (e.g. the Unicode representing “weary face”) are very similar, and they both are used in many situations. Some people use them more so to convey anger, while others use them to convey sadness, and some even use them to convey extreme happiness.
1f610 used neutrally: “They're trying to keep a straight face 1f610 (in reference to this)”
1f610 used to mean annoyed: “Don't even get me started with this topic 1f610”
1f629 used positively: “These PROMposals are so freaking cute! 1f629 1f629”

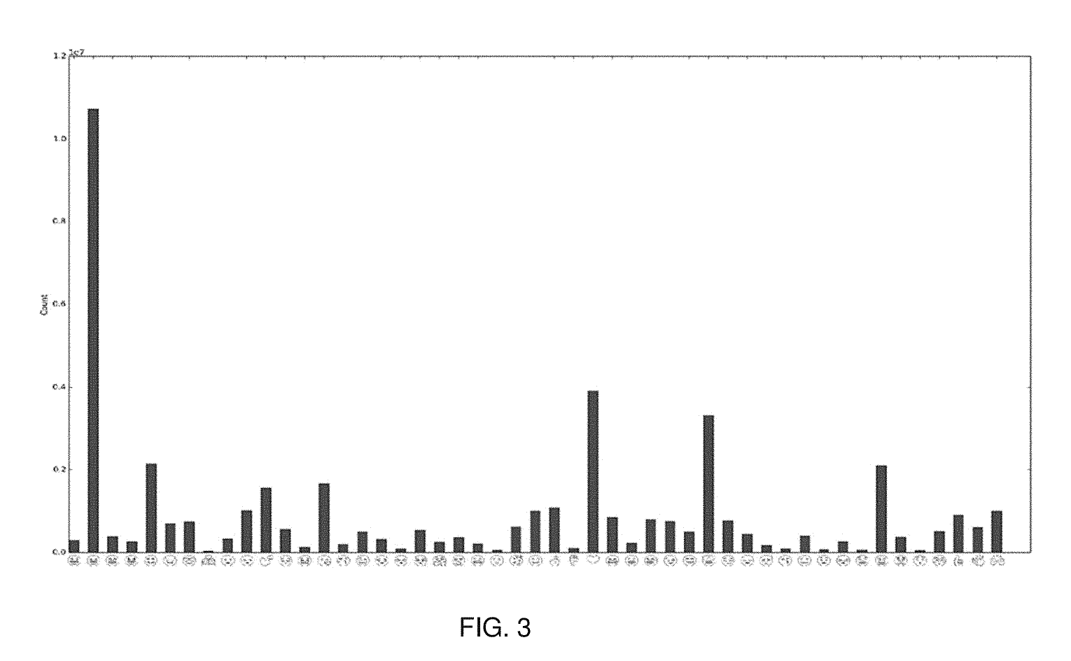

In addition to removing emojis that had conflicting usage, the computing system removed some emojis that were not frequent enough in the collected dataset. This included the cat emojis, for example. FIG. 3 shows the frequency counts of these 49 emojis in the example collected dataset. Any emoji with a frequency count of less than 70,000 was automatically ignored. In particular, the emojis are shown along the X-axis and the frequency count is shown on the Y-axis in FIG. 3.

The above processing steps resulted in a set of 36 emojis. Instead of using these as class labels, the computing system grouped them into sentiment classes. This is because several emojis often convey a similar sentiment with varying degree of the sentiment. For instance, sadness is conveyed using emojis represented by the Unicodes 1f61f, 1f627, 1f61e, 1f616, 1f614, 1f62a and 1f622.

The computing system 104 systematically grouped the emojis together into sentiment classes. In particular, the computing system used a custom Word2Vec model in the Word2Vec neural network module 209. In an example embodiment, the Word2Vec module was trained on 42.3 million tweets and a vocabulary of size 250,000 that includes all of the emojis. Using the feature vectors of the pertinent emojis, the computing system clustered the feature vectors with agglomerative clustering. An initial numbered of clusters (e.g. 10 clusters) were outputted. The resulting clusters are described in Table I.

After experimenting with these clusters, we felt that there are still some emojis left that are not well defined enough in terms of sentiment, specifically those in the clusters with low f-scores, namely, cool, joking, silly, love, and smileys, as Table II demonstrates.

TABLE I
Clustering of 36 emojis into 10 sentiments

| Sentiment | Emojis |
|---|---|
| love | 1f619, 1f60a, 1f61a, 1f60d, 1f618, 1f495 |
| good | 1f44d, 1f44f, 1f44c, 1f64c |
| angry | 1f620, 1f621, 1f624, 1f611, 1f612, 1f634 |
| joking | 1f609, 1f61c, 1f60f |
| silly | 1f60b, 1f60c, 1f61b |
| smileys | 1f606, 1f603, 1f600, 1f604 |
| sad | 1f61f, 1f627, 1f61e, 1f616, 1f614, 1f62a, 1f622 |
| like | 263a, 2764 |
| funny | 1f602 |
| cool | 1f60e |

TABLE II
Precision, recall and f-scores for 10-class classification

| Sentiment | Precision | Recall | F-score |
|---|---|---|---|
| angry | 0.33 | 0.51 | 0.40 |
| cool | 0.32 | 0.34 | 0.33 |
| joking | 0.26 | 0.19 | 0.22 |
| silly | 0.31 | 0.26 | 0.28 |
| funny | 0.34 | 0.39 | 0.37 |
| good | 0.70 | 0.46 | 0.56 |
| love | 0.32 | 0.28 | 0.30 |
| like | 0.58 | 0.66 | 0.62 |
| sad | 0.40 | 0.45 | 0.42 |
| smileys | 0.34 | 0.32 | 0.33 |
| Total | 0.39 | 0.38 | 0.38 |

As part of a filtering process, the computing system removed clusters with low f-scores, except love. The love cluster is kept because it contains emojis that are extremely widely used, with multiple emojis that have been used in over 1 million tweets. With these emojis, the computing system re-ran the agglomerative clustering computations in order to make sure the clusters remained the same given the new emoji set. The results showed that clusters do remain the same. In the example embodiment, the computing system outputted 26 emojis defining 6 sentiment classes. Table III gives the breakdown, and Table IV shows the precision, recall and f-scores for these 6 classes.

TABLE III
Clustering of 26 emojis into 6 sentiments

| Sentiment | Emojis |
|---|---|
| love | 1f619, 1f60a, 1f61a, 1f60d, 1f618, 1f495 |
| good | 1f44d, 1f44f, 1f44c, 1f64c |
| angry | 1f620, 1f621, 1f624, 1f611, 1f612, 1f634 |
| sad | 1f61f, 1f627, 1f61e, 1f616, 1f614, 1f62a, 1f622 |
| like | 263a, 2764 |
| funny | 1f602 |

TABLE IV
Precision, recall and f-scores for 6-class classification

| Sentiment | Precision | Recall | F-score |
|---|---|---|---|
| angry | 0.43 | 0.52 | 0.47 |
| funny | 0.47 | 0.52 | 0.50 |
| good | 0.63 | 0.58 | 0.60 |
| love | 0.53 | 0.46 | 0.49 |
| like | 0.74 | 0.64 | 0.69 |
| sad | 0.49 | 0.50 | 0.50 |
| Total | | | |

To compare the results of the computing system 104 with other existing approaches used in positive and negative sentiment classification, a 2-class classification was executed by the computing system by clustering the emojis into a positive class and a negative class.

The funny class was excluded in this particular example, as it is used in both a positive and a negative connotation. The computing system then recomputed the agglomerative clustering for the remaining emojis, looking for two clusters. Table V shows the breakdown of these 2 classes. The clustering naturally separates emojis with positive sentiments from emojis with negative sentiments. The angry and the sad class merge into one cluster, while the three positive classes merge into another. Table VI shows the precision, recall and f-scores for this clustering.

TABLE V
Clustering of 25 emojis into 2 sentiments

| Sentiment | Emojis |
|---|---|
| positive | 1f619, 1f60a, 1f61a, 1f60d, 1f618, 1f44d, 1f44f, 1f495 |
| | 1f44c, 1f64c, 263a, 2764, |
| negative | 1f620, 1f621, 1f624, 1f611, 1f612, 1f634, 1f61f, |
| | 1f627, 1f61e, 1f616, 1f614, 1f62a, 1f622 |

TABLE VI
Precision, recall and f-scores for 2-class classification

| Sentiment | Precision | Recall | F-score |
|---|---|---|---|
| negative | 0.86 | 0.84 | 0.85 |
| positive | 0.84 | 0.86 | 0.85 |
| Total | | | |

C. Data Preprocessing

The raw data collected from Twitter included all English text tweets (excluding retweets) included a total of 38.1 million tweets. The computing system, using the data collection module 212, only collected and stored tweets that contained an emoji from the list of relevant emojis. Tweets that contained more than one emoji from the list of relevant emojis were removed. To regularize the data, the data collection module removed the following characters: [! ? . , “] from the tweets. The computing system then processed the entire set of messages by converted the text to lowercase, and splitting the messages by whitespace. The computing system further removed all urls and media urls, and replaced them with the keyword URL. The computing system also removed all usernames and hashtags, stripped the symbols @ and # from them, and added them back into the respective messages. The reason for doing this was that there are times where these can be attached to other text or characters without a space separating them.

After the data collection module pre-processed the data, the computing system then assigned sentiments based on the emojis, and took a random sample of the data such that each sentiment had 100,000 tweets. Any emoji that fitted multiple sentiments were removed from the dataset to avoid confusion. The next step was to create a collection of all of the words in the dataset along with their frequency counts. This was performed to exclude infrequent words (e.g. words that occurred less than x times in the entire dataset). In an example embodiment x is 15. The computing system the used all the remaining words as features. Table VII shows the final number of features for each of the 10-class, 6-class and 2-class classification problems.

D. TFIDF

Term frequency inverse document frequency (TFIDF) is an effective way to narrow down on the relevant features.

TABLE VII
Number of features before and after pruning in the 10-
class, 6-class, and 2-class classification problems

| No. of classes | No. of features before | No. of features after |
|---|---|---|
| 10 | 725556 | 21020 |
| 6 | 622307 | 16269 |
| 2 | 214682 | 16017 |

Let D be the corpus of tweets and dbe a tweet in the corpus. For a given word t ind,

$$TFIDF ( t , D ) = {f}_{t , d} ⋆ log ( \frac{N}{\vert \{ d ε D \text{:} t ε d \} \vert} ) ,$$

where f_{t,d} is the frequency of the word tin the tweet d, and N is the number of tweets in the corpus. In this formula, f_{t,d} is the term frequency, while the rest is the inverse document frequency. The inverse document frequency decreases logarithmically as the number of tweets that a word appears in approaches N (the total number of tweets). This means that very common words such as ‘I’, ‘to’, ‘you’ and ‘the’ are devalued because they occur in the largest percent of the documents and therefore, do not convey any significant information about the documents they occur in, while the rarer words are given greater importance and rightly so. In each of our classifiers, we computed the TFIDF scores of each of the features for each of the documents, and passed those scores as inputs to our models.

E. Model Selection

The example classification models used herein are reflective of the two classification tasks at hand: (1) multi-label multi-sentiment classification, and (2) binary positive-negative classification. Support Vector Machine (SVM) was chosen as one of the models because it is a robust binary classifier. Multinomial Naive Bayes (MNB) was chosen because (1) it is a multi-class classifier, (2) it produces probabilities that can be used in the Top 2 selection, and (3) it has been previously shown to be good for text classification tasks. SVM was used in the one-vs-all mode when training for the multi-label sentiment task.

It will be appreciated that these models are used in an example embodiment, and other models used for classification by computing systems may also be used.

F. Top 2 Selection

An issue that was recognized while making sentiment identification for a given tweet is that several tweets arguably had multiple sentiments. As an example,
A tweet in which the author is upset but finds the situation funny as well: “Messaged my older sister that I was pregnant (April Fools) and the stupid girl told my mum. Now mum's incredibly upset w/ me 1f625 1f629 1f602”

Hence, it is reasonable to make multiple predictions for several tweets. In an example embodiment, the computing system has a model with 6 classes, and in such an example embodiment, it may be considered excessive to predict 3 or more classes for a given input. Therefore, the computing system returned the labels with the top two probabilities provided they are “close”. In an example embodiment, the computing system used the below condition to determine whether or not to return labels with the top two probabilities:

$$ψ = \frac{{p}_{2}}{{p}_{1} + {p}_{2}} > δ ,$$

where pᵢ is the i^{th} result (ordered from highest probability to lowest) is correct and is the threshold above which top two labels are returned instead of the top one label. The quantity ranges from 0 (meaning that the classifier is certain about the label with highest probability) to 0.5 (meaning that the classifier finds the labels with the first and the second highest probabilities equally valid).

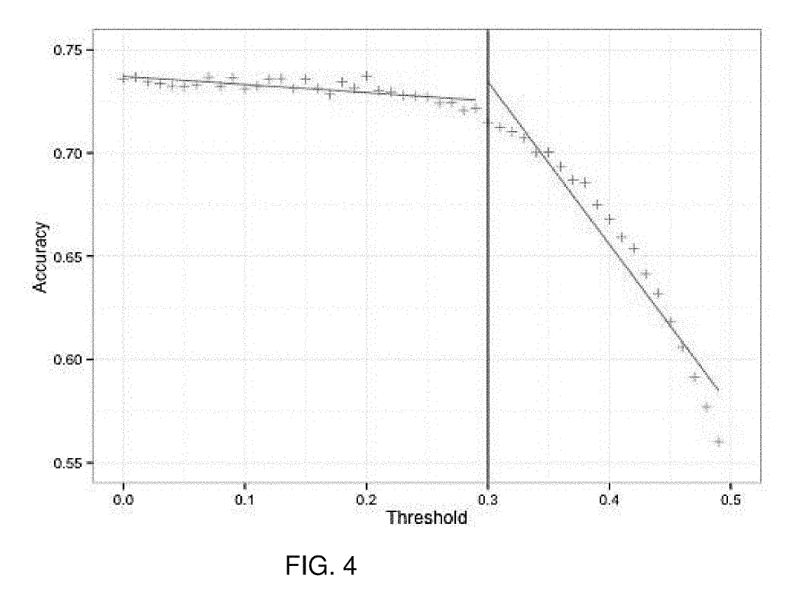

In order to choose a good threshold δ, the computing system varied the value of δ between 0.5 and 0 at 0.1 intervals. In an example embodiment, the corresponding accuracy of the model is plotted in the graph in FIG. 4. It can be seen that the accuracy increases as the values move closer to 0 and decreases as the values move closer to 0.5, as expected. The graph shows an elbow at the point 0.3, where the gains from decreasing it further were marginal compared to the gains from decreasing it up to this point. Hence, we chose 0.3 as value for δ in all our experiments. If the assigned sentiment was in either of the two predicted results, the tweet was marked as successfully predicted.

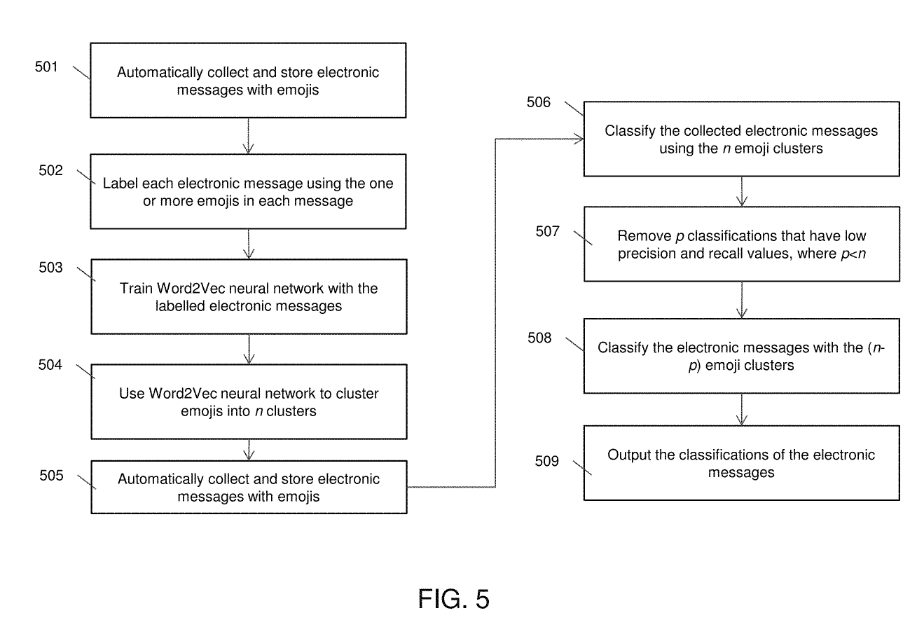

Turning to FIG. 5, example computer executable or processor implemented instructions are provided to classifying electronic messages having emojis.

At block 501, the computing system 104 automatically collects and stores the electronic messages with emojis. The electronic messages may be pre-processed, as noted above.

At block 502, the computing system automatically labels each electronic message using the one or more emojis in each message.

At block 503, the computing system trains a Word2Vec neural network with the labelled electronic messages.

At block 504, the computing system uses the trained Word2Vec neural network to cluster emojis into n clusters, where n is an natural number.

At block 505, the computing system automatically collects and stores new electronic messages with emojis. These electronic messages may be pre-processed, as noted above.

At block 506, the computing system classifies the collected electronic messages using the n emoji clusters.

At block 507, the computing system removes p classifications that have low precision and recall values, where p<n.

At block 508, the computing system classifies the electronic messages with the remaining (n-p) emoji clusters.

At block 509, the computing system outputs the classifications of the electronic messages. These results, for example, are stored in the database 211.

In an example aspect, it is recognized that several emojis appear differently on different platforms, such as iPhone, Android, and Twitter. Consequently, it causes a lot of confusion in the way these emojis are interpreted and used in those platforms. As an example, it is hard to differentiate between a sweat and a tear on some platforms, and consequently they are used interchangeably, whilst that is not the case on other platforms. Therefore, in an example embodiment, the computing system builds models that understand these platform-specific features to improve model performance and allow for the inclusion of emojis that may otherwise be excluded due to confusing usage.

In another example embodiment, the computing system includes one or more deep neural network (DNN) models that improve model learning and performance. For example, Tweets provide an ideal input for a deep learning network because they have a fixed length of 140 characters. Deep learning models are inherently multi-sentiment and allow for multi-labeling. The computing system 104 uses deep learning models to extract more generalized features that can be used for other problems such as topic modelling.

In another example embodiment, the computing system builds and uses a model for each user (e.g. each user account or each user identifier) based on the words/features and emojis that he or she uses in their electronic messages.

### Example Experiments

All results shown in this section are for 10-fold cross-validation unless otherwise specified. We herein use “top 1 selection” to refer to choosing the best class label, and “top 2 selection” to refer to choosing either the best or the top two class labels using the process described above (e.g. under the heading “F. Top 2 Selection”).

A. Two Sentiments Classification Results

In this section, the results for a positive-negative binary sentiment classifier are presented. Recall that the two classes are generated using n=2 in the agglomerative clustering (cf. Table V for the emojis in the two clusters). These classifiers naturally use top 1 selection because there are only two possible labels. Tables IX and X show the results for the binary classifier using a Naive Bayes (NB) and Support Vector Machine (SVM), respectively. The best model is SVM with an accuracy of 84:95% (±0:17%) and an F-score of 0:85 (cf. Table VI). Accuracy from the Naive Bayes model is only marginally lower at 82:75% (±0:26%). The SVM classifier used by the computing system 104 has a significantly better accuracy (+2:75%) than other existing SVM classifiers (cf. Table VIII). The SVM model used by the computing system 104 also has a better accuracy (+2:05%) in comparison to other who classified movie reviews into two sentiments. Table VIII details best results from Barbosa et al., Agarwal et al., and Liu et al. that use twitter data.

B. Ten Sentiments Classification Results

In this section, the results for our ten sentiments classifier are shown. Recall that the ten classes are generated using n=10 in the agglomerative clustering (cf. Table I for the emojis in the ten clusters). Table XI shows the results of using the Multinomial Naive Bayes classifier with top 2 selection. The average overall accuracy is 54:42% (±0:15%). Only two of the ten classes have 70% average accuracy. One of them is like, which also performs well in the six sentiments classification (cf. Section III-C). The cool, joking, silly, smileys and love clusters have less than 50% average accuracy. Additionally, these four classes have the lowest recall and precision (cf. Table II).

C. Six Sentiments Classification Results

In this section, the results for the six sentiments classifier are presented. Recall that the six classes are generated using n=6 in the agglomerative clustering (cf. Table III for the emojis in the six clusters). Table XII displays the results of using our best model—Multinomial Naive Bayes classifier with top 2 selection. The average overall accuracy is 71:6% (±0:22%), which is 17:18% more than the ten class model discussed in the previous section. Five of the six classes have an average accuracy of 70%. The love class has the least accuracy of 63%. However, love is one of the poorly per-forming clusters and is only included due to its abundant usage. The like class has the best precision and recall (cf. Table IV). The like class is an interesting class. It predates Twitter (and most social media platforms), and when agglomerative clustering is run for several n from n=4 to n=16, this class appears as its own class for every choice of n. This shows that over the years people have developed a specific use for the two emojis in this class.

These results can also be compared to Table XIII, which shows the results of using Multinomial Naive Bayes classifier with top 1 selection. Using the top 2 selection results in a gain of nearly 18% in the average overall accuracy. The angry class has a gain of 25:33%, the maximum gain across all classes. The like class has the highest accuracy of 63:79%, which attests to the previously made statement about the distinct usage of this class.

TABLE VIII
Two Sentiments Classification: Comparison

| | Our | | Pang | Barbosa | Agarwal | |
|---|---|---|---|---|---|---|
| Model | Model | Go et al. | et al. | et al. | et al. | Liu et al. |
| NB | 82.75 | 81.3 | 78.7 | — | — | — |
| SVM | 84.95 | 82.2 | 82.9 | 81.3 | 75.39 | 82.52 |

TABLE IX
Two Sentiments Classification: Naive Bayes Classifier

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| positive | 0.7772 | 0.7755 | 0.7775 | 0.7831 | 0.7741 | 0.7714 | 0.7639 | 0.7739 | 0.7641 | 0.7761 | 0.7737 |
| negative | 0.8797 | 0.8793 | 0.8781 | 0.8809 | 0.8842 | 0.8817 | 0.8801 | 0.8823 | 0.8842 | 0.8826 | 0.8813 |
| Average | 0.8284 | 0.8274 | 0.8278 | 0.8320 | 0.8291 | 0.8266 | 0.8220 | 0.8281 | 0.8241 | 0.8293 | 0.8275 |

TABLE X
Two Sentiments Classification: SVM Classifier

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| positive | 0.8622 | 0.8640 | 0.8640 | 0.8640 | 0.8631 | 0.8610 | 0.8646 | 0.8602 | 0.8645 | 0.8645 | 0.8619 |
| negative | 0.8385 | 0.8353 | 0.8353 | 0.8353 | 0.8345 | 0.8421 | 0.8375 | 0.8408 | 0.8356 | 0.8356 | 0.8372 |
| Average | 0.8503 | 0.8497 | 0.8503 | 0.8462 | 0.8488 | 0.8515 | 0.8510 | 0.8468 | 0.8505 | 0.8500 | 0.8495 |

TABLE XI
Ten Sentiments Classification: Multinomial Naive Bayes Classifier using Top 2 selection

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| angry | 0.7211 | 0.7238 | 0.7183 | 0.7181 | 0.7196 | 0.7163 | 0.7253 | 0.7174 | 0.7303 | 0.7186 | 0.7209 |
| cool | 0.4951 | 0.4805 | 0.4882 | 0.4862 | 0.4881 | 0.4907 | 0.4802 | 0.4822 | 0.4882 | 0.4883 | 0.4868 |
| joking | 0.3662 | 0.3602 | 0.3725 | 0.3619 | 0.3723 | 0.3633 | 0.3593 | 0.3671 | 0.3601 | 0.3680 | 0.3651 |
| silly | 0.4357 | 0.4412 | 0.4364 | 0.4322 | 0.4345 | 0.4468 | 0.4363 | 0.4419 | 0.4423 | 0.4400 | 0.4387 |
| funny | 0.6095 | 0.6061 | 0.6026 | 0.6062 | 0.6140 | 0.5988 | 0.6053 | 0.6099 | 0.6132 | 0.6227 | 0.6088 |
| good | 0.5437 | 0.5422 | 0.5295 | 0.5419 | 0.5452 | 0.5376 | 0.5400 | 0.5424 | 0.5371 | 0.5431 | 0.5403 |
| love | 0.4464 | 0.4401 | 0.4502 | 0.4502 | 0.4496 | 0.4544 | 0.4474 | 0.4591 | 0.4497 | 0.4466 | 0.4494 |
| like | 0.7154 | 0.7189 | 0.7088 | 0.7175 | 0.7155 | 0.7103 | 0.7123 | 0.7089 | 0.7152 | 0.7102 | 0.7133 |
| sad | 0.6265 | 0.6334 | 0.6276 | 0.6310 | 0.6279 | 0.6403 | 0.6334 | 0.6406 | 0.6271 | 0.6360 | 0.6324 |
| smileys | 0.4830 | 0.4916 | 0.4833 | 0.4832 | 0.4871 | 0.4860 | 0.4839 | 0.4932 | 0.4857 | 0.4905 | 0.4868 |
| Average | 0.5443 | 0.5438 | 0.5417 | 0.5428 | 0.5454 | 0.5445 | 0.5423 | 0.5463 | 0.5449 | 0.5464 | 0.5442 |

To round off the results, a multi-class classifier was executed using an one-vs-all SVM. The computing system used only the top 1 selection results since SVM cannot return two results. SVM returns marginally better (+1:97%) accuracy than the MNB model with top 1 selection (cf. Table XIII and Table XIV).

D. Six Sentiments Classification: TFIDF Vs. Counts

All example experiments reported so far were conducted us-ing TFIDF feature values. To understand the impact of TFIDF scores, we ran an experiment using only the counts as feature values (cf. Table XV). Comparing Table XV to Table XII, it can be seen that using TFIDF scores produces a model more accurate (+4:9%) than using simple counts. The angry class has the maximum increase (+9:55%) in accuracy among all classes.

TABLE XII
Six Sentiments Classification: Multinomial Naive Bayes Classifier using Top 2 selection

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| angry | 0.7747 | 0.7690 | 0.7660 | 0.7792 | 0.7661 | 0.7725 | 0.7673 | 0.7667 | 0.7624 | 0.7735 | 0.7697 |
| funny | 0.7033 | 0.7106 | 0.7086 | 0.7101 | 0.7058 | 0.7150 | 0.7167 | 0.6995 | 0.7052 | 0.7121 | 0.7087 |
| good | 0.6865 | 0.6907 | 0.6949 | 0.6847 | 0.6790 | 0.6885 | 0.6880 | 0.6900 | 0.6839 | 0.6917 | 0.6878 |
| love | 0.6330 | 0.6340 | 0.6421 | 0.6329 | 0.6410 | 0.6342 | 0.6338 | 0.6268 | 0.6340 | 0.6445 | 0.6356 |
| like | 0.7743 | 0.7696 | 0.7788 | 0.7806 | 0.7714 | 0.7675 | 0.7801 | 0.7666 | 0.7790 | 0.7732 | 0.7741 |
| sad | 0.7210 | 0.7104 | 0.7182 | 0.7123 | 0.7257 | 0.7175 | 0.7143 | 0.7177 | 0.7130 | 0.7186 | 0.7169 |
| Average | 0.7155 | 0.7141 | 0.7181 | 0.7166 | 0.7148 | 0.7159 | 0.7167 | 0.7112 | 0.7129 | 0.7189 | 0.7155 |

TABLE XIII
Six Sentiments Classification: Multinomial Naive Bayes Classifier using Top 1 selection

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| angry | 0.5110 | 0.5211 | 0.5244 | 0.5133 | 0.5118 | 0.5093 | 0.5210 | 0.5172 | 0.5161 | 0.5244 | 0.5164 |
| funny | 0.5021 | 0.5111 | 0.5225 | 0.5140 | 0.5098 | 0.5149 | 0.5130 | 0.5102 | 0.5196 | 0.5129 | 0.5130 |
| good | 0.5939 | 0.5835 | 0.5848 | 0.5882 | 0.5885 | 0.5755 | 0.5820 | 0.5860 | 0.5869 | 0.5848 | 0.5848 |
| love | 0.4542 | 0.4502 | 0.4658 | 0.4678 | 0.4575 | 0.4629 | 0.4662 | 0.4569 | 0.4618 | 0.4658 | 0.4609 |
| like | 0.6436 | 0.6338 | 0.6354 | 0.6362 | 0.6396 | 0.6272 | 0.6404 | 0.6419 | 0.6422 | 0.6354 | 0.6379 |
| sad | 0.4982 | 0.5008 | 0.4947 | 0.5049 | 0.5022 | 0.5015 | 0.5083 | 0.5011 | 0.5030 | 0.4947 | 0.5010 |
| Average | 0.5338 | 0.5334 | 0.5363 | 0.5374 | 0.5349 | 0.5319 | 0.5385 | 0.5356 | 0.5383 | 0.5363 | 0.5357 |

TABLE XIV
Six Sentiments Classification: SVM Classifier using Top 1 selection

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| angry | 0.4910 | 0.4885 | 0.4980 | 0.4903 | 0.4883 | 0.4884 | 0.4920 | 0.4926 | 0.4960 | 0.4881 | 0.4913 |
| funny | 0.5157 | 0.5167 | 0.5097 | 0.5252 | 0.5175 | 0.5197 | 0.5211 | 0.5197 | 0.5146 | 0.5256 | 0.5186 |
| good | 0.6128 | 0.6098 | 0.6109 | 0.6131 | 0.6118 | 0.6052 | 0.6133 | 0.6112 | 0.6026 | 0.5986 | 0.6089 |
| love | 0.5686 | 0.5664 | 0.5609 | 0.5661 | 0.5637 | 0.5582 | 0.5663 | 0.5593 | 0.5695 | 0.5644 | 0.5643 |
| like | 0.6174 | 0.6034 | 0.6117 | 0.6099 | 0.6171 | 0.6153 | 0.6169 | 0.6140 | 0.6197 | 0.6122 | 0.6138 |
| sad | 0.5315 | 0.5357 | 0.5339 | 0.5346 | 0.5352 | 0.5310 | 0.5362 | 0.5427 | 0.5340 | 0.5375 | 0.5352 |
| Average | 0.5562 | 0.5534 | 0.5542 | 0.5565 | 0.5556 | 0.5530 | 0.5576 | 0.5566 | 0.5561 | 0.5544 | 0.5554 |

TABLE XV
Six Sentiments Classification: Multinomial Naive Bayes Classifier using Counts and Top 2 selection

| Sentiment | CV 1 | CV 2 | CV 3 | CV 4 | CV 5 | CV 6 | CV 7 | CV 8 | CV 9 | CV10 | Average |
|---|---|---|---|---|---|---|---|---|---|---|---|
| angry | 0.6694 | 0.6802 | 0.6753 | 0.6683 | 0.6796 | 0.6762 | 0.6714 | 0.6736 | 0.6777 | 0.6700 | 0.6742 |
| funny | 0.6638 | 0.6660 | 0.6652 | 0.6599 | 0.6582 | 0.6666 | 0.6585 | 0.6565 | 0.6584 | 0.6641 | 0.6617 |
| good | 0.6683 | 0.6692 | 0.6700 | 0.6702 | 0.6759 | 0.6747 | 0.6777 | 0.6730 | 0.6686 | 0.6680 | 0.6716 |
| love | 0.6127 | 0.6032 | 0.7584 | 0.6072 | 0.6172 | 0.6028 | 0.6012 | 0.6112 | 0.6028 | 0.6082 | 0.6072 |
| like | 0.7511 | 0.7530 | 0.6053 | 0.7419 | 0.7513 | 0.7510 | 0.7509 | 0.7476 | 0.7538 | 0.7565 | 0.7516 |
| sad | 0.6307 | 0.6308 | 0.6343 | 0.6265 | 0.6333 | 0.6379 | 0.6394 | 0.6322 | 0.6248 | 0.6373 | 0.6327 |
| Average | 0.6660 | 0.6671 | 0.6681 | 0.6623 | 0.6693 | 0.6682 | 0.6665 | 0.6657 | 0.6644 | 0.6674 | 0.6665 |

In a general example embodiment, a computing system is provided, comprising: a communication device to automatically obtain electronic messages having emojis; a memory device to store the electronic messages and one or more classifiers configured to identify n emoji classifications; and one or more processors. The one or more processors at least: classify the electronic messages using the one or more classifiers into the n emoji classifications; remove p classifications from the n emoji classifications that are characterized by a value lower than a given threshold; classify electronic messages remaining in the (n-p) emoji classifications; and output the classifications of the electronic messages remaining in the (n-p) emoji classifications.

The computing system is able to execute these operations for electronic messages containing text in different languages, not just English.

In an example embodiment, the computing system also executes the following operations:

a. Obtain electronic messages (e.g. tweets) for a given query;
b. For each sentence of each electronic message, go through each word and pass it through the sentiment model to get a positive probability and a negative probability for that word. The words that have a high probability of being either positive or negative are the “adjective-like” words, for example, good, bad, like, hate, love, etc. For each such word, we also consider the next and the previous word to form a bigram, like “don't love”, “hate it”, etc.
c. Then, for each sentence of each electronic message, delete stopwords to get a list “noun-like” words. For example, if the computing system deletes stopwords from “I hate their customer service”, the computing system will produce an electronic message with the text “hate customer service”.
d. Delete the “adjective-like” words from the list of “noun-like” words (if any), and associate the “adjective-like” words to the “noun-like” words on a per sentence per electronic message basis.
e. Finally, collect all such “adjective-like-noun-like” pairs from all the sentences of all the electronic messages and sort them by their frequency of occurrence. Output the top few results from this list.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing systems described herein or any component or device accessible or connectable thereto. Examples of components or devices that are part of the computing systems described herein include server machines and computing devices. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A computing system comprising:
a communication device to automatically obtain electronic messages having emojis;
a memory device to store the electronic messages and one or more classifiers configured to identify n emoji classifications;
one or more processors to at least:
classify the electronic messages using the one or more classifiers into the n emoji classifications;
remove p classifications from the n emoji classifications that are characterized by a value lower than a given threshold;
classify electronic messages remaining in the (n-p) emoji classifications;
output the classifications of the electronic messages remaining in the (n-p) emoji classifications.

2. The computing system of claim 1, wherein the one or more processors pre-process the electronic messages before classifying the electronic messages.

3. The computing system of claim 1 wherein the memory device further comprises a Word2Vec neural network, and the one or more processors at least:
obtain an initial set of electronic messages, each one having one or more emojis;
automatically label each one of the electronic messages in the initial set using the one or more emojis;
training the Word2Vec neural network to with the labelled electronic messages; and
using the trained Word2Vec neural network to cluster emojis in the initial set of electronic messages into the n classifications.
